(19) United States
(12) Patent Application Publication
(10) Pub. No.: US 2025/0260357 A1
(43) Pub. Date: Aug. 14, 2025

(54) PORTABLE CONSUMER ELECTRONIC APPARATUS

(71) Applicant: SOLAR OUTDOOR LIGHTING SOLUTIONS LTD, London (GB)

(72) Inventors: Marcus MAXWELL-BATTEN, London (GB); Pak Yin Brian WONG, London (GB)

(73) Assignee: SOLAR OUTDOOR LIGHTING SOLUTIONS LTD, London (GB)

(21) Appl. No.: 19/100,378

(22) PCT Filed: Aug. 1, 2023
(86) PCT No.: PCT/IB2023/057786

§ 371 Date: Jan. 31, 2025

(30) Foreign Application Priority Data
Aug. 2, 2022 (GB) 2211243.7

(51) Int. Cl. H02S 10/40; H02S 20/32; H02S 40/20; H02S 40/38

(52) U.S. Cl. CPC H02S 10/40; H02S 20/32; H02S 40/20; H02S 40/38

(57) ABSTRACT

A portable consumer electronic apparatus that includes a portable charging hub configured for an off-grid power storage and supply. The portable charging hub includes a rechargeable energy storage device and a power circuitry that includes an input connection port for charging the rechargeable energy storage device and one or more output connection ports to be removably and electrically coupled to one or more external electronic devices for an off-grid power supply. The portable consumer electronic apparatus further includes a portable light module to be removably arranged on the charging portion configured as a base to support the portable light module when being charged and a portable solar tracker configured to be removably and electrically coupled to the input connection port for an off-grid charging. A method for controlling the portable consumer electronic apparatus is also disclosed.

### TECHNICAL FIELD

This invention relates to portable consumer electronics. In particular, though not exclusively, this invention relates to a portable consumer electronic apparatus and a method for controlling the portable consumer electronic apparatus.

### BACKGROUND

Generally, a number of electronic devices, such as smartphones, mobile phones, music players, cameras, and light sources, are used by a number of users. Typically, electronic devices may be charged through both off-grid and on-grid modes of charging. The on-grid mode of charging is comparatively easy due to the availability of the mains power supply, as compared to the off-grid mode of charging, such as via renewable energy sources (e.g. solar energy). Energy supply from portable power banks are insufficient for people who like to perform outdoor activities, like camping, or spend extended periods of time off-grid. Currently, there are very few reliable options available for keeping phones and small electronic devices charged continuously without having to connect to a mains supply.

Attempts have previously been made to provide a continuous source of off-grid power supply. However, existing solar generators and products that exploit renewable energy sources are not only costly and bulky (and hence not truly portable) but also have limited solar energy intake issues due to a fixed angle set up, for example, of solar panels. There also exists high capacity power banks with inbuilt-lights but those are not suitable for the different outdoor activities for an extended period of time. Some portable power stations are available but again those are large, heavy, and not reasonably portable to the extent that they can be carried by a user for any outdoor activities. Thus, there exists a technical problem of how to develop a truly portable apparatus that is flexible to be used both indoors and outdoors, reliable and versatile enough for off-grid power generation, storage, and supply suitable power for different outdoor activities for extended period of time and at the same time be light weight and have a sufficiently small form factor so that it can be carried by a human user.

### SUMMARY OF THE INVENTION

A first aspect of the invention provides a portable consumer electronic apparatus, comprising:
a portable charging hub configured for an off-grid power storage and supply, wherein the portable charging hub comprises:
   a rechargeable energy storage device;
   a power circuitry connected to the rechargeable energy storage device, wherein the power circuitry comprises an input connection port configured for charging of the rechargeable energy storage device, and one or more output connection ports configured to be removably and electrically coupled to one or more external electronic devices for an off-grid power supply to the one or more external electronic devices; and
   a charging portion arranged at a first surface of the portable charging hub;
a portable light module that is configured to be removably arranged on the charging portion at the first surface of the portable charging hub, wherein the charging portion is configured as a base to support the portable light module when being charged by the portable charging hub; and
a portable solar tracker that is configured to be removably and electrically coupled to the input connection port of the portable charging hub for an off-grid charging of the rechargeable energy storage device.

Herein, the disclosed portable consumer electronic apparatus is truly portable as its individual components are not only modular in nature but also have a small form factor, adding to its portability without any compromise in functionality or quality. For instance, the disclosed portable consumer electronic apparatus is light weight (for example, less than about 10 kg in total weight) and can be easily dismantled due to its modular nature and can, for example, be placed into a rucksack to be carried by a user. The disclosed portable consumer electronic apparatus can provide light with desired brightness and power personal electronic devices with charging functionality in off-grid usage scenarios. Alternatively stated, the disclosed portable consumer electronic apparatus is reliable and versatile enough for off-grid power generation, storage, and supply suitable for different outdoor activities for extended periods of time. Moreover, the disclosed portable consumer electronic apparatus supports charging its rechargeable energy storage device from a mains supply when available (e.g., when used indoors) as well as from solar energy (e.g., when used outdoors) using the portable solar tracker, thereby manifesting desired usage flexibility for both indoors and outdoors. The disclosed portable consumer electronic apparatus provides an efficient and reliable portable charging device with a continuous source of charging for the off-grid lighting source, such as for the portable light module. The portable charging hub provides off-grid power storage and supply to charge one or more electronic devices, with an improved backup supply. Thus, the portable consumer electronic apparatus is very useful and well suited for use in any outdoor activities, such as camping trips, expeditions, treks, festivals, off-grid vacations, wildlife off-grid photography, off-grid living, and the like.

Throughout the present disclosure, the term “portable charging hub” as used herein refers to a portable device that can be used to charge the one or more electronic devices. The term “rechargeable energy storage device” refers to a device, such as a rechargeable battery or battery pack or battery module, which is configured to store power and further supply the stored power to the one or more electronic devices. The battery module can be a single or a double battery. In a double battery system, if either the first one or the second battery is charging, the other battery bank is free to discharge. Moreover, the term “charging portion” corresponds to a defined area that is arranged at the top surface (i.e., the first surface) of the portable charging hub. However, the term “charging portion” may also be referred to as a charging bay on the portable charging hub without limiting the scope of the present disclosure. Furthermore, the charging portion is configured to charge a portable light module. In this regard, the term “portable light module” is configured to be removably arranged in the charging portion to charge its own rechargeable energy storage device to provide the off-grid lighting. Examples of the portable light module may include, but are not limited to, a light-emitting diode (LED) lantern, a LED dimmable tower light, a white LED lantern, an red, green, blue (RGB) LED light, LED bulb, or any other portable light module.

The portable consumer electronic apparatus described herein comprises the portable charging hub that is configured to provide an off-grid power storage and supply to charge the one or more electronic devices such as smartphones, mobile phones, tablets, musical devices, gaming devices, and the like. The portable charging hub includes the rechargeable energy storage device and the power circuitry. The rechargeable energy storage device is configured to store energy and further provide a backup power supply to the one or more electronic devices.

Moreover, the power circuitry comprises an input connection port configured for charging the rechargeable energy storage device, and one or more output connection ports configured to be removably and electrically coupled to the one or more external devices for an off-grid power supply to the one or more external electronic devices. The input connection port may be, for example, an input power connection port, a micro USB port, a mini USB port, or any type or input connection port without limiting the scope of the present disclosure. The rechargeable energy storage device is charged through the portable solar tracker (i.e., generally an off-grid power supply) or through a mains power supply (i.e., an on-grid supply when available). The power circuitry is configured to charge the one or more external electronic devices (e.g., personal electronic devices, such as a smartphone, a smartwatch, an audio system, etc. of a user) through the one or more output connection ports. In an example, the output connection port refers to a USB port, a socket, a two pin or three pin port or any type of output connection port without limiting the present scope of the present disclosure. Other examples of the one or more external electronic devices includes smartphones, mobile phones, portable music players, portable gaming devices, digital cameras and the like, which may be charged through the portable charging hub.

In accordance with an embodiment, the rechargeable energy storage device is chargeable via the input connection port of the power circuitry through a mains power supply. The charging of the rechargeable energy storage device through the mains power supply (when available) provides flexibility to operate the disclosed apparatus when used indoors.

Furthermore, the portable charging hub comprises the charging portion that is arranged at the first surface (i.e., the top surface) of the portable charging hub. In other words, the charging hub is configured as a base to support the portable light module when being charged by the portable charging hub. In an implementation, when the portable light module comes in contact with the charging portion, an inbuilt battery of the portable light module starts charging. Alternatively stated, the portable charging hub enables off-grid charging of the portable light module when the portable light module is placed on a defined area designated as the charging portion on the surface of the portable charging hub.

In accordance with an embodiment, the charging portion comprises the electrical energy transmitter, and the portable light module includes the electrical energy receiver. In this regard, the term “electrical energy transmitter” may be configured to transmit the power stored in the rechargeable energy storage device of the portable charging hub to charge the portable light module. The electrical energy transmitter (e.g., contact pins) may be included in the charging portion of the portable charging hub. Furthermore, the term “electrical energy receiver” may be included in the portable light module. Further, the electrical energy receiver (e.g., contact pins that may be complementary to the contact pins of the charging portion) is configured to receive power from the electrical energy transmitter that is included in the charging portion of the portable charging hub. A particular benefit of this configuration is that it reduces (e.g. eliminates) the need for cables for connecting the charging portion with the electrical energy transmitter, further enhancing the portability of the portable consumer electronic apparatus.

In addition, the portable consumer electronic apparatus comprises the portable solar tracker that is configured to be removably and electrically coupled to the input connection port of the portable charging hub for the off-grid charging of the rechargeable energy storage device. In other words, the portable solar tracker is connected to the portable charging hub to supply off-grid charging of the rechargeable energy storage device to further charge the one or more external devices. The portable solar tracker comprises a solar panel and a tracking unit.

In this regard the term “tracking unit” refers to a unit that is configured to track a direction indicating a maximum solar energy capturing potential as compared to the other directions around the portable solar tracker through the solar panel. The tracking unit enables the portable solar tracker to capture the solar energy through the solar panel and further convert the captured solar energy to provide an off-grid power supply. The tracking unit is configured to track a direction indicating a maximum solar energy capture potential as compared to other directions around the portable solar tracker. Hence, the portable consumer electronic apparatus utilizes the renewal energy (i.e., the solar energy) with improved efficiency to provide off-grid power storage and supply.

In accordance with an embodiment, the portable charging hub further comprises a display for displaying a state of charge of a rechargeable energy storage device. The state of charge (SoC) of the rechargeable energy storage device provides a current charge level in accordance with the storage capacity of the rechargeable energy storage device. For example, the display may be used to display a current charge level, such as 70%, 80%, or 100% charged and available to recharge the external electronic devices, such as smartphone, camera, or personal electronics of a user.

In accordance with an embodiment, the portable solar tracker comprises a solar panel to capture solar energy. The portable solar tracker is configured to be removably and electrically coupled to the input connection port of the portable charging hub to provide off-grid charging of the rechargeable energy storage device. The captured solar energy is further transmitted to the rechargeable energy storage device that is included in the portable charging hub through the input connection port to charge the rechargeable energy storage device. The rechargeable energy storage device further charges the one or more external electronic devices. In addition, the portable solar tracker includes the tracking unit that further includes a printed circuit board (PCB).

In accordance with an embodiment, the PCB comprises a microcontroller connected to a transistor array, a plurality of photodiodes, an input power supply, and an operational amplifier. Firstly, each of the plurality of photodiodes is configured to receive solar energy, and then convert the received solar energy into an output signal (e.g., a digital ‘1’ or ‘0’). Thereafter, the output of each of the plurality of photodiodes is received by the operational amplifier, and then by the controller, which is configured to be operated based on the input power supply. In such embodiment, the PCB further comprises a rolling ball sensor switch and a tilt switch. The microcontroller is further connected to each of the rolling ball sensor switch and the tilt switch to control a movement of the tracker unit around an axis when sun light falls on the plurality of photodiodes based on the tracked direction indicating the maximum solar energy capture potential. Therefore, the output signal of each of the plurality of photodiodes is used to control the operations of the tilt switch, and the rolling ball sensor switch, such as for rotating or tilting the portable solar tracker. Hence, the portable solar tracker is configured to efficiently charge the portable charging hub by harnessing a maximum solar energy available throughout the day.

In accordance with an embodiment, the portable light module comprises another rechargeable energy storage device that functions independently of the rechargeable energy storage device of the portable charging hub. The other rechargeable energy storage device is configured to provide energy to the portable light module. Moreover, the other rechargeable energy storage device of the portable light module is charged through the portable charging hub. The energy stored in the rechargeable energy storage device is transmitted through the electrical energy transmitter of the charging portion (of the portable charging hub) to the other rechargeable energy storage device. The other rechargeable energy storage device receives the energy through the electrical energy receiver and further stores the received energy.

This enables the portable light module to act as an off-grid light source and retain its portability.

In accordance with an embodiment, the portable light module comprises an input connection port configured for charging directly from the base of the charging portion of the portable charging hub. The input connection port may be, for example, an input power connection port, a micro USB port, a mini USB port, a USB-C port or any type of input connection port without limiting the scope of the present disclosure.

The portable consumer electronic apparatus as described herein has a total (i.e. combined weight of the components of the apparatus) weight of the apparatus of preferably less than about 10 kg. This has the benefit of making the consumer electronic apparatus as described herein truly portable, i.e. it can be readily carried and transported by one person on foot, such as in a rucksack or backpack. Preferably the portable consumer electronic apparatus has a total weight of the apparatus of less than about 5 kg, more preferably less than about 2 kg and particularly preferably less than about 1 kg, e.g. 50 to 1000 g, preferably 100 to 900 g, more preferably 200 to 800 g.

In accordance with an embodiment, the portable consumer electronic apparatus, as described herein, can be configured as a 12000 mAh and 25000 mAh system.

The 12000 mAh system comprises:
a portable charging hub, as described herein, particularly with:
   the battery size is 12000 mAh,
   two input connections: one USB C fast charge port and one standard USB port;
solar tracker, as described herein, particularly with:
   10-Watt and 6 Volt solar panel;
a portable light module as described herein.

The 25000 mAh system comprises:
a portable charging hub, as described herein, particularly with:
   a double battery, which is sized 25000 mAh,
   three input connections: two USB C fast charge ports and one standard USB port;
solar tracker, as described herein, particularly with:
   20-Watt and 6 Volt solar panel;
a portable light module as described herein. A second aspect of the invention provides a computer implemented method of controlling a portable consumer electronic apparatus. The method comprising:
establishing one or more independent wireless connections of a user device with one or more of: a portable charging hub, a portable light module, and a portable solar tracker of the portable consumer electronic apparatus;
monitoring, by the user device, a state of charge of a rechargeable energy storage device of the portable charging hub via the established one or more independent wireless connections;
monitoring, by the user device, a charging rate from the portable solar tracker to the rechargeable energy storage device of the portable charging hub via the established one or more independent wireless connections;
monitoring, by the user device, a state of charge of the portable light module via the established one or more independent wireless connections; and
controlling, by the user device, the portable consumer electronic apparatus via the established one or more independent wireless connections to change an intrinsic function of the portable consumer electronic apparatus.

The computer implemented method of controlling the portable consumer electronic apparatus is used to monitor and intelligently control various modular components of the portable consumer electronic apparatus, such as the portable charging hub, the portable solar tracker, and the portable light module more efficiently and easily through a user device.

In this regard, the term “one or more independent wireless connections” corresponds to the wireless connections established between the portable charging hub, the portable light module, the portable solar tracker and a user device. Moreover, the examples of the user device may include but are not limited to, a smartphone, a tablet, a portable computing device, or an electronic device. The user device is configured to monitor and control each of the portable charging hub, the portable light module, and the portable solar tracker of the portable consumer electronic apparatus. After the establishment of the one or more independent wireless connections, the user device controls the portable consumer electronic apparatus to change an intrinsic function of the portable consumer electronic apparatus. For example, the user device establishes an independent connection with the portable charging hub and monitors the charging status of the portable charging hub. Similarly, the user device establishes another independent connection with the portable light module and monitors the intrinsic functions, such as a brightness level and a power state of the portable light module.

In accordance with an embodiment, the controlling of the portable consumer electronic apparatus includes controlling the portable light module to change the intrinsic function. Optionally, the controlling of the portable light module includes controlling brightness level of the portable light module, power state of the portable light module. In addition, the controlling of the portable light module also includes controlling a colour tone, such as RED, GREEN, BLUE (RGB) colour tone of the portable light module. For example, the user device may be used to remotely increase or decrease the brightness level of the portable light module, without any physical contact.

The user device is also used to turn on or off the portable light module through the established another independent connection. Furthermore, the user device establishes the independent wireless connection with the portable solar tracker to increase or decrease the charging rate from the portable solar tracker to the rechargeable energy storage device of the portable charging hub. Hence, the establishment of one or more independent wireless connections, monitoring and controlling of the portable consumer electronic apparatus through the user device is used to handle the portable consumer electronic apparatus wirelessly without any physical contact.

In accordance with an embodiment, the controlling of the portable consumer electronic apparatus further comprises controlling the portable solar tracker to increase or decrease the charging rate from the portable solar tracker to the rechargeable energy storage device of the portable charging hub based on a user-preference. The user-preference is received via an application interface of an application installed in the user device to increase or decrease the charging rate, which corresponds to the change of the intrinsic function. Optionally, the user device is used to control the charging rate according to the energy required by the rechargeable energy storage device. Hence, this feature enables the portable solar tracker to control the flow of energy from the portable solar tracker to the rechargeable energy storage device.

In accordance with an embodiment, the controlling of the portable consumer electronic apparatus further includes controlling the portable charging hub to switch OFF charging of the rechargeable energy storage device of the portable charging hub when the state of charge (SoC) of the rechargeable energy storage device of the portable charging hub reaches a predefined SoC value. The switching OFF of the charging of the rechargeable energy storage device corresponds to the change of the intrinsic function. Optionally, the SOC of the rechargeable energy storage device corresponds to a defined charging value that represents the total amount of charge stored in the rechargeable energy storage device. Therefore, if the storage capacity of the rechargeable energy storage device reaches the defined value (i.e., a defined SOC value), then the user device is used to switch OFF the charging of the rechargeable energy storage device to prevent the unnecessary flow of energy.

In accordance with an embodiment, the controlling of the portable consumer electronic apparatus further includes controlling the portable charging hub to switch OFF charging of the portable light module when the state of charge (SoC) of another rechargeable energy storage device of the portable light module reaches a predefined SoC value while being arranged on a charging portion of the portable charging hub. Furthermore, the switching OFF of the charging of the portable light module corresponds to the change of the intrinsic function. Optionally, the SOC of another rechargeable energy storage device (of the portable light module) corresponds to a defined value that represents the total amount of charge stored in another rechargeable energy storage device. Hence, when the storage capacity of portable light module reaches the defined value (i.e., the SOC value), the user device is used to switch OFF the charging of the rechargeable energy storage device to prevent the unnecessary flow of energy.

A third aspect of the invention provides a computer program product comprising a non-transitory computer-readable storage medium having computer-readable instructions stored thereon, the computer-readable instructions being executable by a computing device comprising a processor to execute the method according to the second aspect of the invention.

Optionally, the computer program product is implemented as an algorithm, embedded in a software stored in the non-transitory computer-readable storage medium. The non-transitory computer-readable storage medium may include, but is not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a block diagram of a portable consumer electronic apparatus with its components, in accordance with an embodiment of the invention;

FIG. 2 is an illustration that represents an exemplary arrangement of various components of a portable consumer electronic apparatus, in accordance with an embodiment of the present disclosure;

FIGS. 3A and 3B are illustrations depicting different perspective views of a portable charging hub of a portable consumer electronic apparatus, in accordance with an embodiment of the present disclosure;

FIG. 4 is an illustration that represents an exemplary dismantled view of a portable solar tracker of a portable consumer electronic apparatus, in accordance with an embodiment of the present disclosure;

FIG. 5 is a circuit diagram that represents one or more connections of various components arranged on a printed circuit board (PCB) of a solar tracker, in accordance with an embodiment of the present disclosure;

FIGS. 6A and 6B are illustrations that represents different perspective views of a PCB that is included in a portable consumer electronic apparatus, in accordance with an embodiment of the present disclosure.

FIG. 7 is an illustration that represents monitoring of a portable charging hub and a solar tracker of a portable consumer electronic apparatus by a user device, in accordance with an embodiment of the present disclosure; and

FIG. 8 is a flowchart of a computer implemented method of (for) controlling a portable consumer electronic apparatus, in accordance with an embodiment of the present disclosure.

### DETAILED DESCRIPTION

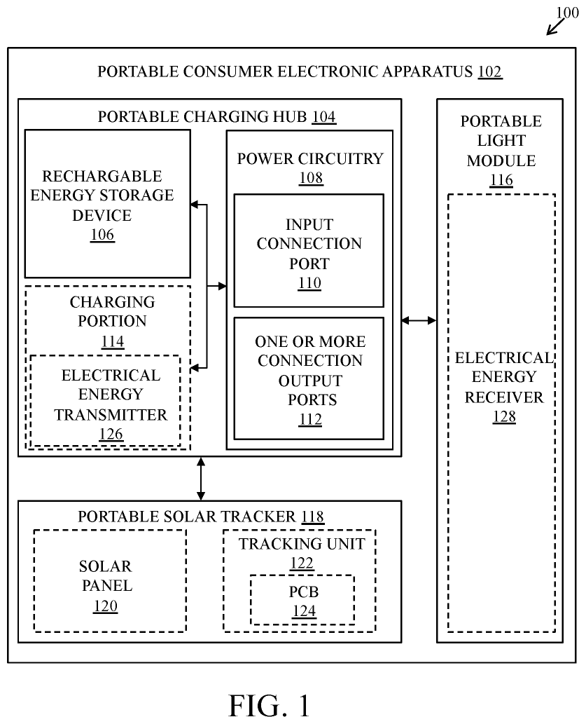

Referring to FIG. 1, there is shown is a block diagram 100 of a portable consumer electronic apparatus, in accordance with an embodiment of the present disclosure. There is shown a block diagram 100 of a portable consumer electronic apparatus 102 that includes a portable charging hub 104, a portable light module 116, and a portable solar tracker 118. Furthermore, the portable charging hub 104 includes a rechargeable energy storage device 106, and a power circuitry 108 connected with the rechargeable energy storage device 106. In addition, the power circuitry 108 includes an input connection port 110 that is used to charge the rechargeable energy storage device 106, such as from a mains power supply, or from the energy captured by the portable solar tracker 118. In other words, the input connection port 110 is also used to store the energy captured by the portable solar tracker 118 to the rechargeable energy storage device 106. Optionally, the storage capacity of the rechargeable storage energy device ranges from 2000 mAh to 35000 mAh, preferably from 5000 mAh to 25000 mAh, more preferably from 8000 mAh to 20000 mAh, and even more preferably from 10000 mAh to 15000 mAh, and for example at least about 10000 mAh.

The power circuitry 108 further includes the one or more output connection ports 112 that are used to charge one or more external electronic devices, such as a mobile phone, a digital camera, a portable electronic device, and the like. In other words, the one or more output connection ports 112 are configured to be removably and electrically coupled to one or more external electronic devices for an off-grid power supply to the one or more external electronic devices. In an example, the power circuitry 108 includes two output connection ports. However, the power circuitry 108 can includes a plurality of output connection ports, without limiting the scope of the invention. Optionally, the one or more output connection ports 112 corresponds to a universal serial bus (USB) port, and the like.

The portable solar tracker 118 of the portable consumer electronic apparatus 102 further includes a solar panel 120 to capture the solar energy and a tracking unit 122 to track the direction indicating the maximum solar energy capture potential as compared to the other directions around the portable solar tracker 118. In an implementation, the portable solar tracker 118 provides an automated single axis rotation (e.g., left to right rotation). In another implementation, the portable solar tracker 118 enables manual secondary adjustment in second axis (e.g., up and down movement). In an example, the solar panel produces power in a range of 2 watts to 25 watts. The portable solar tracker 118 is configured to be removably and electrically coupled to the input connection port 110 of the portable charging hub 104 for an off-grid charging of the rechargeable energy storage device.

In addition, the portable charging hub 104 includes a charging portion 114 that is used to charge the portable light module 116 through an electrical energy transmitter 126. Moreover, the portable light module 116 includes an electrical energy receiver 128 that is used to receive the energy transmitted by the electrical energy transmitter 126. In addition, the portable light module 116 is configured to be removably arranged on the charging portion 114 of the portable charging hub 104, then the electrical energy transmitter 126 transmits the energy stored in the rechargeable energy storage device 106 to the electrical energy receiver 128. In another implementation, the portable light module 116 includes textured grip at the base of the portable light module 116 to provide comfortable and non-slippery arrangement on the charging portion 114 of the portable charging hub 104. Moreover, the charging portion 114 is configured as a base to support the portable light module 116 when being charged by the portable charging hub 104.

The portable consumer electronic apparatus 102 provides an efficient and reliable portable charging devices with continuous source of charging for the off-grid lighting source, such as for the portable light module 116. The portable consumer electronic apparatus 102 further provides an off-grid power storage and supply to charge one or more electronic devices, with improved backup supply. In addition, the portable consumer electronic apparatus 102 provides an off-grid lighting source. Thus, the portable consumer electronic apparatus 102 is used for different consumers that are engaged in outdoor activities such as campaigning trips, expeditions, treks, festivals, off-grid vacations, wildlife off-grid photography, off-grid living and the like.

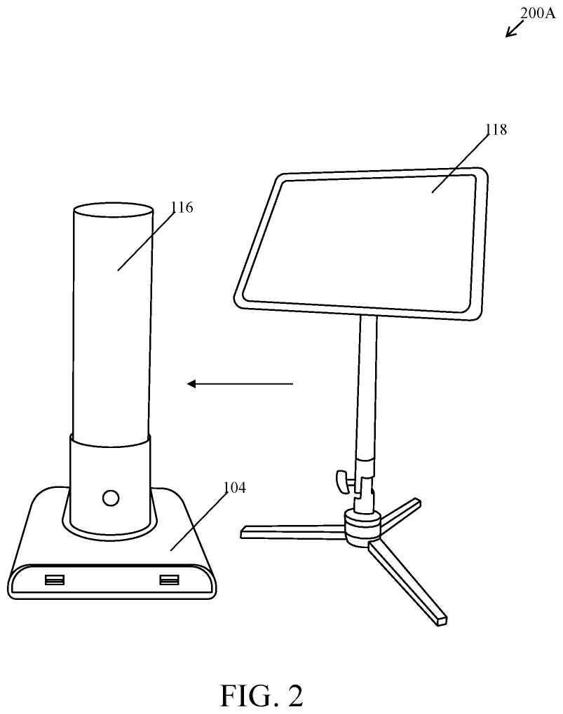

Referring to FIG. 2, there is shown an illustration that illustrates an exemplary arrangement of various components of a portable consumer electronic apparatus, in accordance with an embodiment of the present disclosure. The portable consumer electronic apparatus 102 as shown in illustration 200 includes the portable charging hub 104, the portable light module 116 and the portable solar tracker 118. The portable charging hub 104 configured to be connected with the portable solar tracker 118 through an input connection port (such as the input connection port 110 of FIG. 1) of the portable charging hub 104 to charge the rechargeable energy storage device 106. The rechargeable energy storage device 106 stores the energy to charge the one or more external electronic devices In addition, the portable charging hub 104 includes the charging portion 114 on a top surface of the portable charging hub 104 and the portable light module 116 is configured to be placed on the charging portion 114 of the portable charging hub 104, such as to charge the other rechargeable energy storage device of the portable light module 116. In an implementation, the storage capacity of the other rechargeable energy storage device ranges from 2000 mAh to 4000 mAH. Therefore, the portable consumer electronic apparatus 102 provides off-grid lighting and may be used for charging of the one or more electronic devices. The portable consumer electronic apparatus 102 is useful for off-grid usage, for example, in outdoor activities such as camping trips, expeditions, treks, festivals, vacations, wildlife off-grid photography, off-grid living and the like.

In this exemplary implementation, each of the length and breath of the portable charging hub may range from 120 mm to 180 mm. The height of the portable charging hub may range from 25 mm to 45 mm. The diameter of the portable light module 116 may range from 35 mm to 95 mm and the height of the portable light module 116 may ranges from 235 mm to 295 mm. Such compact physical dimensions indicate a small form factor and a true portable nature of the portable consumer electronic apparatus 102.

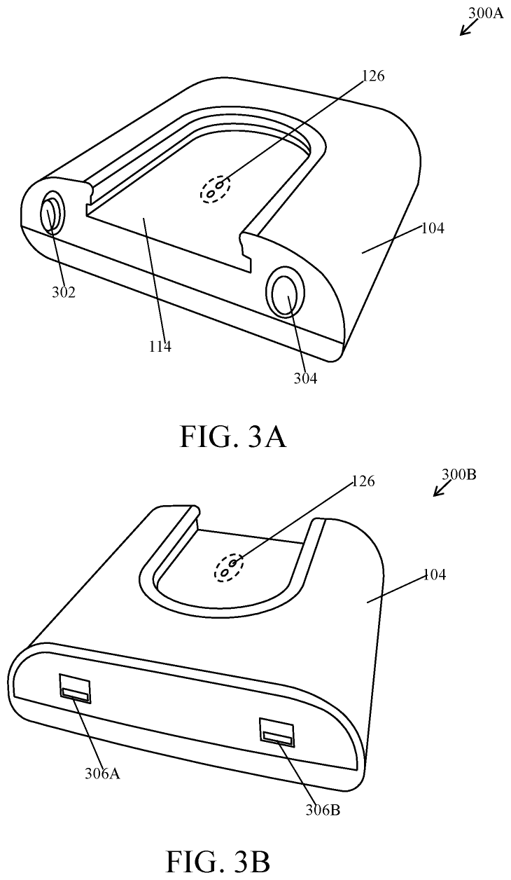

Referring to FIGS. 3A and 3B, as shown are illustrations that illustrates different perspective views of a portable charging hub of a portable consumer electronic apparatus, in accordance with an embodiment of the present disclosure. FIGS. 3A and 3B are shown in conjunction with elements from FIGS. 1 and 2. Referring to FIG. 3A, there is shown an illustration 300A that illustrates an input connection port 304, and an ON/OFF switch button 302. The ON/OFF switch button 302 enables the consumer to switch on or switch off the portable charging hub 104. Moreover, the portable charging hub 104 includes a rechargeable energy storage device (such as the rechargeable energy storage device 106 of FIG. 1) that is charged through the input connection port 304 (such as the input connection port 110 of FIG. 1). Optionally, the rechargeable energy storage device 106 is charged through the portable solar tracker 118 or through a mains power supply.

In addition, in the FIG. 3B, there is shown an illustration 300B that illustrates the one or more output ports, such as a first output port 306A and a second output port 306B of the portable charging hub 104. Furthermore, there is shown the electrical energy transmitter 126 to charge the other rechargeable energy storage device of the portable light module 116. The one or more output connection ports, such as the first output connection port 306A and the second output connection port 306B, are used to connect the one or more external electronic devices with the portable charging hub 104. The one or more external electronic devices are charged through the first output port 306A and the second output port 306B by the transmission of energy from the rechargeable energy storage device 106 to the one or more external electronic devices. For example, a smartphone may be charged by the portable charging hub 104 through the first output port 306A. Similarly, another electronic device may be charged from the portable charging hub 104 through the second output port 306B simultaneously or separately.

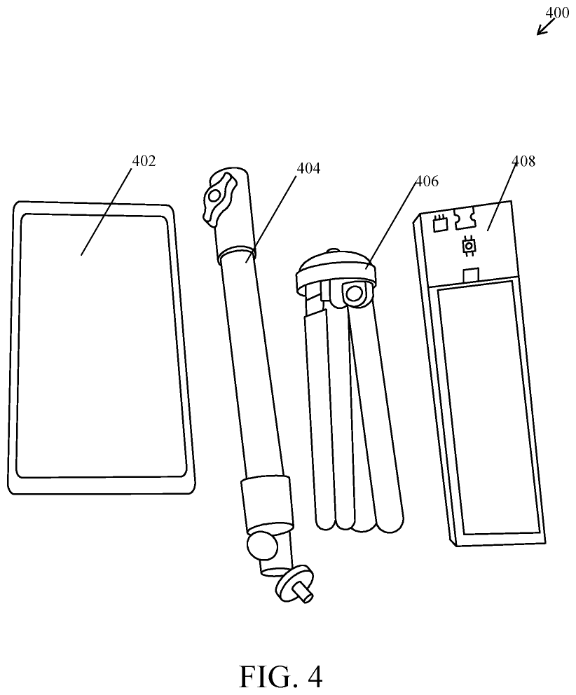

Referring to FIG. 4, shown is an illustration that illustrates a dismantled view of a portable solar tracker of a portable consumer electronic apparatus, in accordance with an embodiment of the present disclosure. FIG. 4 is shown in conjunction with elements from FIGS. 1, 2, and 3. There is shown an illustration 400 that illustrates a dismantled view of a portable solar tracker (such as the portable solar tracker 118 as shown in the FIG. 1) that includes various parts such as a solar panel 402, an extendable tripod stand 404, a foldable tripod legs 406, and a tracking unit 408. The extendable tripod stand 404 is configured to be attached to the foldable tripod legs 406, such as combination of both act as a base for the solar panel 402. Furthermore, the tracking unit 408 is configured to be attached to the solar panel 402 and used to track the direction of the solar panel 402. Moreover, the tracking unit 408 includes the PCB (such as the PCB 124 as shown in FIG. 1) that is configured to be attached with the solar panel 402 to move the solar panel 402 in the direction indicating the maximum solar energy capturing potential as compared to the other directions around the portable solar tracker 118. In addition, the tracking unit 408 is used to indicate the direction in which the solar tracker can be moved so that the solar panel 402 can capture maximum solar energy. Therefore, the compact nature of the portable solar tracker enhances the portability of the portable consumer electronic apparatus 102, due to which the portable consumer electronic apparatus 102 can be easily carried for outdoor activities such as campaign, trips, expeditions, treks, festivals, off-grid vacations, wildlife off-grid photography, off-grid living and the like.

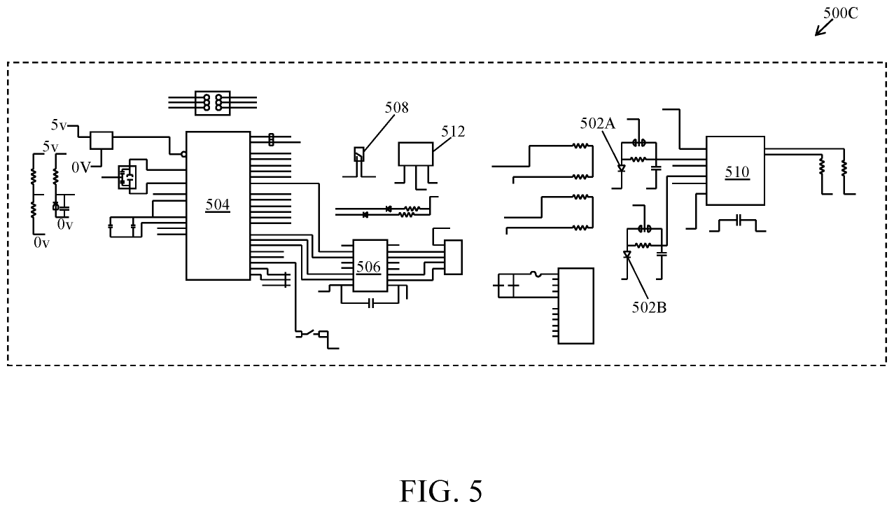

Referring to FIG. 5, there is shown is a circuit diagram that represents one or more connections of various components arranged on a PCB, in accordance with an embodiment of the present disclosure. FIG. 5 is shown in conjunction with elements from FIGS. 1, 2, 3, and 4. There is shown a circuit diagram 500 that includes a microcontroller 504 connected to a transistor array 5106, a plurality of photodiodes (such as a first photodiode 502A, and a second photodiode 502B), and an operational amplifier 510. Firstly, the plurality of photodiodes such as the first photodiode 502A and the second photodiode 502B detects the solar energy, and then each photodiode converts received solar energy into electric signals and transmits the electric signals to the operational amplifier 510. Furthermore, the operational amplifier 510 amplifies the electric signals and further transmits the electric signals to the microcontroller 504. Furthermore, the circuit diagram 500 includes a rolling ball sensor switch 512 and a tilt switch 508. In addition, the microcontroller 504 is further connected to the rolling ball sensor switch 512 and the tilt switch 508 to control a movement of the tracking unit 122 around an axis based on the electric signals received from the first photodiode 502A and the second photodiode 502B, for example, based on the tracked direction indicating the maximum solar energy capture potential. In addition, the microcontroller 504 controls functions of all the components, such as of the operational amplifier 510, the rolling ball sensor switch 512, the tilt switch 508, the transistor array 506 and the like without limiting the scope of the present disclosure. Thus, the circuit diagram 500 that is included in the tracking unit 122 of the portable solar tracker 118 is used to capture and convert the maximum solar energy to store the power in the rechargeable energy storage device 106 of the portable charging hub 104. Hence, this enables the portable consumer electronic apparatus 102 to provide efficient and reliable off-grid power supply to charge the one or more electronic devices.

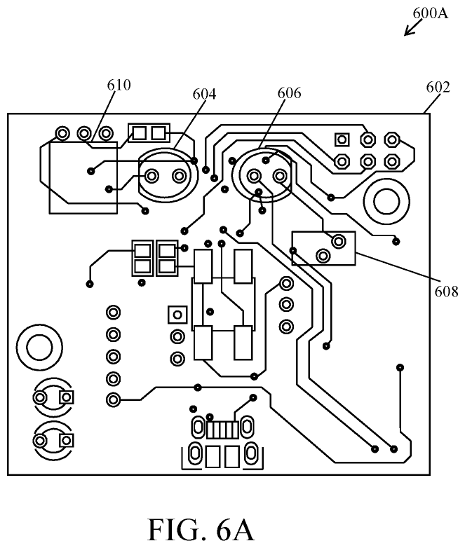

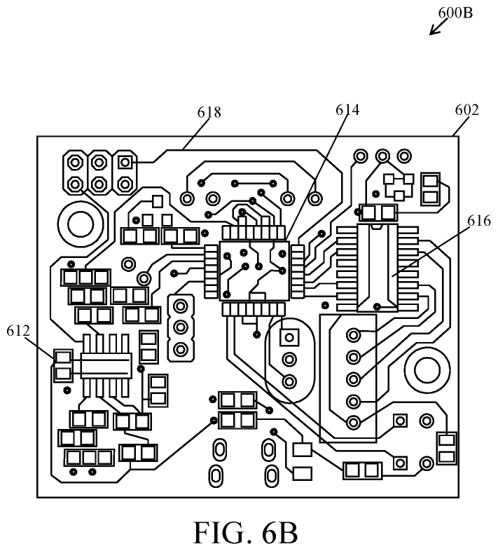

Referring to FIGS. 6A and 6B, as shown are illustrations that depicts different perspective views of a printed circuit board that is included in a portable consumer electronic apparatus, in accordance with an embodiment of the present disclosure. FIGS. 6A and 6B are shown in conjunction with elements from FIGS. 1, 2, 3A, 3B, and 4. Referring to FIG. 6A, there is shown a top view 600A of a printed circuit board (PCB) 602, which is a double-sided PCB. The PCB 602 includes a plurality of component reference designators such as a first component reference designator 604, a second component reference designator for 606, a third component reference designator 608, and a fourth component reference designator 610. Moreover, referring to FIG. 6B there is shown a bottom view 600B of the printed circuit board 602 that represents the plurality of component reference designators such as a fifth component reference designator 612, a sixth component reference designator 614, and a seventh component reference designator 616. The plurality of component reference designator represents different reference areas for the arrangement of various components on the PCB. The first component reference designator 604 represents the reference area for placement of the arrangement of a photodiode (such as the first photodiode 502A of FIG. 5). Similarly, the second component reference designator 606 represents the area for placement of another photodiode (such as the second photodiode 502B of FIG. 5). In addition, the third component reference designator 608 represents the area for placement of a rolling ball sensor switch (such as the rolling ball sensor switch 512 of FIG. 5), and the fourth component reference designator 610 represents the area for placement of the tilt switch (such as the tilt switch 508 of FIG. 5). Additionally, in the bottom view 600B of the PCB 602, the fifth component reference designator 612 represents the area for placement of an operational amplifier (such as the operational amplifier 510 of FIG. 5). Furthermore, the sixth component reference designator 614 represents the area for placement of the microcontroller (such as the microcontroller 504 of FIG. 5). Similarly, the seventh component reference designator 616 represents the area for placement of the transistor array (such as the transistor array 506 of FIG. 5). The PCB 602 further includes a plurality of conductive metal strips such as a conductive metal strip 618 (e.g., metallic trace lines or electrically conductive lines) that are used to provide electrical connection points on the top surface of the PCB 602. Similarly, each of the plurality of conductive metal strips are used for interconnection of the plurality of components indicated by the first component reference designator 604, the second component reference designator 606, and the like. In addition, a plurality of active and passive components are also arranged on different places, such to provide a desired current supply to other components, and also to provide a desired voltage and clock cycles to the microcontroller. As a result, the microcontroller can be placed on the PCB 602, which is further used for the movement of the portable solar tracker 118 in the direction having maximum solar energy.

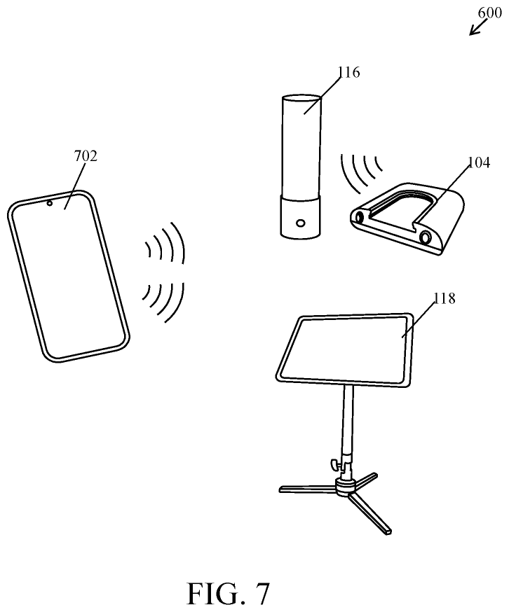

Referring to FIG. 7 is an illustration that illustrates one or more wireless independent connection between a portable charging hub, a user device, and a solar tracker of a portable consumer electronic apparatus, in accordance with an embodiment of the present disclosure. FIG. 7 is shown in conjunction with elements from FIGS. 1,2,3,4,5, and 6. Referring to FIG. 7, there is shown a user device 702 that is used to establish the one or more independent wireless connection with the portable charging hub 104. The portable charging hub 104 may have one or more wired or wireless connections with the portable solar tracker 118 and/or the portable light module 116 (preferably a wired connection in the case of the portable solar tracker 118, and preferably a wireless connection in the case of the portable light module 116). Examples of the user device 702 may include but are not limited to, a computer, a personal digital assistant, a portable computing device, or an electronic device without limiting the scope of the present disclosure. The user device 702 is configured to monitor and control each of the portable charging hub 104, the portable light module 116, and the portable solar tracker 118 of the portable consumer electronic apparatus 102. After the establishment of the one or more independent wireless connections, the user device 702 controls the portable consumer electronic apparatus 102 to change an intrinsic function of the portable consumer electronic apparatus 102. For example, the user device 702 establishes an independent connection with the portable charging hub 104 and monitors the charging status of the portable charging hub 104. Similarly, the user device 702 establishes another independent connection simultaneously with the portable light module 116 and monitors the intrinsic functions such as a brightness level and a power state of the portable light module 116. The user device 702 is also used to turn on or off the portable light module 116 through the established another independent connection. Furthermore, the user device 702 establishes a connection (preferably a wired connection) with the portable solar tracker 118 to increase or decrease the charging rate from the portable solar tracker 118 to the rechargeable energy storage device 106 of the portable charging hub 104. Hence, the establishment of one or more independent wireless connections, monitoring and controlling of the portable consumer electronic apparatus 102 through the user device 702 is used to handle the portable consumer electronic apparatus 102 wirelessly without any physical contact.

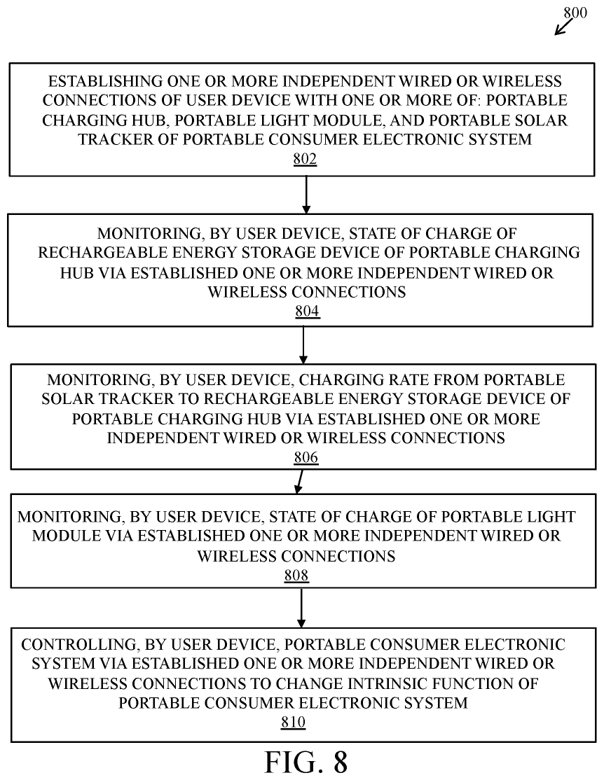

Referring to FIG. 8, shown is an illustration of a flowchart depicting steps of a computer implemented method of controlling a portable consumer electronic apparatus, in accordance with an embodiment of the present disclosure. At step 802, one or more independent wireless connections are established by the user device 702 with the portable charging hub 104. The portable charging hub 104 may have one or more wired or wireless connections with the portable solar tracker 118 and/or the portable light module 116 of the portable consumer electronic apparatus 102 (preferably a wired connection in the case of the portable solar tracker 118, and preferably a wireless connection in the case of the portable light module 116). At step 804, a state of charge of the rechargeable energy storage device 106 of the portable charging hub 104 is monitored by the user device 702 via established one or more independent wired or wireless connections. At step 806, the charging rate from the portable solar tracker 118 to the rechargeable energy storage device 106 of the portable charging hub 104 is monitored by the user device 702 via the established one or more independent wired or wireless connections. At step 808, a state of charge of the portable light module 116 is monitored by the user device 702 via the established one or more independent wired or wireless connections. At step 810, the portable consumer electronic apparatus 102 is controlled by the user device 702 via the established one or more independent wired or wireless connections to change an intrinsic function of the portable consumer electronic apparatus 102.

The aforementioned steps are only illustrative, and other alternatives can also be provided where one or more steps are added, one or more steps are removed, or one or more steps are provided in a different sequence without departing from the scope of the claims herein.

1. A portable consumer electronic apparatus, comprising:
a portable charging hub configured for an off-grid power storage and supply, wherein the portable charging hub comprises:
a rechargeable energy storage device;
a power circuitry connected to the rechargeable energy storage device, wherein the power circuitry comprises an input connection port configured for charging of the rechargeable energy storage device, and one or more output connection ports configured to be removably and electrically coupled to one or more external electronic devices for an off-grid power supply to the one or more external electronic devices; and
a charging portion arranged at a first surface of the portable charging hub;
a portable light module that is configured to be removably arranged on the charging portion at the first surface of the portable charging hub, wherein the charging portion is configured as a base to support the portable light module when being charged by the portable charging hub; and
a portable solar tracker that is configured to be removably and electrically coupled to the input connection port of the portable charging hub for an off-grid charging of the rechargeable energy storage device.

2. The portable consumer electronic apparatus according to claim 1, wherein the portable charging hub further comprises a display for displaying a state of charge of the rechargeable energy storage device.

3. (canceled)

4. The portable consumer electronic apparatus according to claim 1, wherein the portable solar tracker comprises:
a solar panel to capture solar energy; and
a tracking unit that comprises a printed circuit board (PCB), wherein the tracking unit is configured to track a direction indicating a maximum solar energy capture potential as compared to other directions around the portable solar tracker.

5. The portable consumer electronic apparatus according to claim 1, wherein the PCB comprises a microcontroller connected to a transistor array, a plurality of photodiodes, an input power supply, and an operational amplifier.

6. The portable consumer electronic apparatus according to claim 4, wherein the PCB further comprises a rolling ball sensor switch and a tilt switch, and wherein the microcontroller is further connected to each of the rolling ball sensor switch and the tilt switch to control a movement of the tracker unit around an axis when sun light falls on the plurality of photodiodes based on the tracked direction indicating the maximum solar energy capture potential.

7. The portable consumer electronic apparatus according to claim 1, wherein the rechargeable energy storage device is further chargeable via the input connection port of the power circuitry through a main power supply for an in-grid charging.

8. The portable consumer electronic apparatus according to claim 1, wherein the charging portion comprises an electrical energy transmitter and the portable light module comprises an electrical energy receiver.

9. The portable consumer electronic apparatus according to claim 1, wherein the portable light module comprises another rechargeable energy storage device that functions independent of the rechargeable energy storage device of the portable charging hub.

10. The portable consumer electronic apparatus according to claim 1, wherein the total weight of the apparatus is less than about 10 kg.

11. A computer implemented method of controlling a portable consumer electronic apparatus, the method comprising:
establishing one or more independent wireless connections of a user device with one or more of: a portable charging hub, a portable light module, and a portable solar tracker of the portable consumer electronic apparatus;
monitoring, by the user device, a state of charge of a rechargeable energy storage device of the portable charging hub via the established one or more independent wireless connections;
monitoring, by the user device, a charging rate from the portable solar tracker to the rechargeable energy storage device of the portable charging hub via the established one or more independent wireless connections;
monitoring, by the user device, a state of charge of the portable light module via the established one or more independent wireless connections; and
controlling, by the user device, the portable consumer electronic apparatus via the established one or more independent wireless connections to change an intrinsic function of the portable consumer electronic apparatus.

12. The method according to claim 10, wherein the controlling of the portable consumer electronic apparatus comprises controlling the portable light module to change the intrinsic function, which is at least one of: a brightness level of the portable light module, a power state of the portable light module, or an RED, GREEN, BLUE (RGB) colour tone of the portable light module.

13. The method according to claim 10, wherein the controlling of the portable consumer electronic apparatus further comprises controlling the portable solar tracker to increase or decrease the charging rate from the portable solar tracker to the rechargeable energy storage device of the portable charging hub based on a user-preference, and wherein the user-preference is received via an application interface of an application installed in the user device, and wherein the increase or decrease of the charging rate corresponds to the change of the intrinsic function.

14. The method according to claim 10, wherein the controlling of the portable consumer electronic apparatus further comprises controlling the portable charging hub to switch OFF charging of the rechargeable energy storage device of the portable charging hub when the state of charge (SoC) of the rechargeable energy storage device of the portable charging hub reaches a predefined SoC value, and wherein the switching OFF of the charging of the rechargeable energy storage device corresponds to the change of the intrinsic function.

15. The method according to claim 10, wherein the controlling of the portable consumer electronic apparatus further comprises controlling the portable charging hub to switch OFF a charging of the portable light module when the state of charge (SoC) of another rechargeable energy storage device of the portable light module reaches a predefined SoC value while being arranged on a charging portion of the portable charging hub, and wherein the switching OFF of the charging of the portable light module corresponds to the change of the intrinsic function.

16. A computer program product comprising a non-transitory computer-readable storage medium having computer-readable instructions stored thereon, the computer-readable instructions being executable by a computing device comprising a processor execute the computer implemented method claimed in claim 1.
